(19) United States
(12) Patent Application Publication
(10) Pub. No.: US 2004/0103284 A1
(43) Pub. Date: May 27, 2004

(54) System and method for archiving authenticated research and development records

(76) Inventor: Thomas N. Barker, Vestal, NY (US)

Correspondence Address: Louis J. Franco, Law Office of Louis J. Franco, 250 Arbor Street, Lunenburg, MA, 01462, US

(21) Appl. No.: 10/306,241

(22) Filed: Nov. 27, 2002

(51) Int. Cl. G06F 12/14

(52) U.S. Cl. 713/176

(57) ABSTRACT

A data processing system including a write-once data-recording medium facilitates the creation and archiving of authenticated data records. In various aspects, a data-file depositor authenticates contents of a data file destined for recordation on the data-recording medium by associating with the data file a unique, depositor-specific signal indicative of the data-file depositor's intent to authenticate the data file contents. Additionally, various implementations facilitate the association with the data file of a witness-specific signal which, when so associated, constitutes evidence of a witness candidate's intent to verify at least the existence of the data file as of a time certain. In various implementations, a time of occurrence of at least one predetermined event related to at least one of the creation, saving and witnessing of the data file is associated with the data file. In accordance with some implementations, data files are placed in the custody of a data custodian.

### BACKGROUND

1. Field

Although not so limited in its utility or scope, implementations of the present invention are particularly useful to engineers, scientists and other research and development personnel in creating unalterable, time-stamped records of conception, reduction to practice and other activity related to the act of inventing.

2. Brief Description of an Illustrative Environment and Related Art

Corporations, laboratories and other institutions engaged in research and development efforts frequently rely upon pooled human resources for the creation of new products and methods that may become the subject of patent applications. Although the importance of thorough record-keeping of all “inventive” activity beginning with a date of conception is strongly indicated by United States law relating to various legal proceedings including, for instance, patent interferences before the Board of Patent Appeals and Interferences, the fact of the matter is that legally “proper” record-keeping often suffers because it is extremely tedious and time-consuming and diverts the efforts of inventive personnel from the business of inventing. At odds in the unique “first-to-invent” system of the United States are the need for thorough, credible documentation of the inventive activity surrounding an invention and the need for inventors to focus on their primary mission of inventing for themselves or their employers. For instance, one of the longest standing and most favored forms of inventive documentation is the traditional inventor's notebook in which an inventor makes handwritten, witnessed entries documenting inventive activity. The traditional notebook system endures on the theory that hardbound notebooks into which notes are entered and dated on sequentially numbered pages cannot be falsified by one inclined to fraud and one or more conspiring witnesses.

Another difficulty arises from the separate maintenance of a traditional inventor's notebook by each joint inventor involved in a particular development project; the disjointed nature of the collective joint inventors' notes requires piecing together to “see the full picture” and to trace the development of the invention. Moreover, instances involving multiple inventors can result in unwitting duplicative effort if, for example, one inventor is unaware, or unable to readily ascertain records, of the activity of other inventors involved in the project.

Accordingly, there exists a need for an archiving system including a secure repository for containing unalterable documentary entries to which an inventor involved in the development of an invention can submit notes and other documentation related to inventive activity. Moreover, there is a need for a centralized system that associates the documented contributions of each inventor associated with a particular project for ready retrieval by designated personnel authorized to access such records.

### SUMMARY

In various implementations, an unalterable and secure data repository system includes a computer network. Communicatively linked through the network are a data store device and one or more user input devices through which a person desiring to send data to the data store device for archiving communicates with the system. In a typical implementation, the data store device includes a write-once medium such as, by way of non-limiting example, a recordable CD or CD-R. In such implementations, once a data file is saved to the write-once medium, it can be retrieved for inspection (e.g., viewing or listening), and duplicates can be saved or printed, for instance, but the data of a particular archived data file cannot be altered.

Illustrative user input devices enabling the entry of various data file types (e.g., textual, photographic, videographic and recorded sound) include a scanner, a digital camera, a networked personal computer, a computer terminal, a fax machine, a telephone and a voice recorder. In response to a command from the user, a data file is created, data are recorded and the data file, or a copy thereof, is communicated to the data store device and associated with an indicium of the time of entry of the data file and a code (e.g., a project number) enabling association of the data file with other data files relating to the same project. Further associated with the data file is an indicium unique to the user archiving the data file and constituting the user's “signature.”

The sequential recordation of data files relating to a particular project, regardless of source, facilitates the orderly subsequent retrieval of data files relating to that project. In short, the centralization of project-related data files originating from disparate sources allows one desiring to trace the development and status of a research and development project to access and “seamlessly” examine the various and cumulative contributions of multiple inventors involved in the project. In contradistinction, under a system in which each inventor within a project group maintains his or her own traditional inventor's notebook, project supervisory personnel are compelled to collect the various inventors' notebooks and then mentally “collate” the notebook entries in order to formulate an appreciation for the sequence of invention development. Additionally, the resolution of the important issue of whom within a group of inventors contributed which subject matter to an invention is facilitated by, for example, the selective retrieval of data files archived by each of one or more individuals within the inventor group. Moreover, by retrieving “all files” between, for instance, the date of conception and the date of constructive or actual reduction to practice of the invention, the issue of whether adequate reasonable diligence in reducing the invention to practice was exerted is more clearly resolved by having in a single “project folder” data files evidencing the contributory developmental activity of each inventor within the project group.

An illustrative method of creating and archiving an authenticated data record in a data processing system having a data storage device including a write-once data recording medium, for example, includes a combination of at least some of the steps to be described herein below.

A user of the data system creates a data file intended for deposit (e.g., saving) to the write-once data-recording medium. The user (e.g., data-file depositor) secures the data file by associating with the data file an access code such that the contents of the data file can be properly accessed only by an individual that is at least one of (i) in possession (e.g., has knowledge) of the access code and (ii) enabled to a implement a method of file access that is independent of knowledge of the access code. An illustrative example of the latter method could involve, for example, a portable computer (e.g., a so-called “laptop” or “notebook” computer) that includes programmed information authorizing access to data files by one in possession of the computer. If the data file is one for which user authentication is desired, the file depositor indicates an express manifestation of his or her intent to authenticate the contents of the data file by inputting into the system, and associating with the data file, a unique, depositor-specific signal (e.g., a user-specific code or password) indicative of such intent. A code permitting access, but not the ability to alter the file, for example, may be what is commonly referred to as a “public key,” used to encrypt a file. The user-specific signal may be what is referred to as a “private key” known only to a specific user/data-file depositor, for example. Although a private key typically facilitates access to a data file for purposes of alteration, in a typical implementation of the present invention, a filedepositor's association of a private key is used as a “signature” to evidence intent to authenticate a data file. That is, in various implementations, not even the creator and depositor of the data file can alter the data file contents once his or her code has been associated with the data file. By preventing alteration subsequent to a user's association of his or her “digital signature” with a data file, the evidentiary value of the data file is enhanced. Alteration of the data file subsequent to the association of a user's unique signal with the file is prevented, in various aspects, by communicating the data file through the data processing system for writing to the write-once data-recording medium. In addition, a time related to a relevant stage in at least one of the creation and saving of the file is associated with the data file. For instance, in various implementations, associated with the data file is the time of at least one of (i) the completion of data entry into the file, (ii) the associating with the data file of the unique, depositor-specific signal, (iii) the communication of the data file to the data processing system and (iv) the completion of writing of the data file to the write-once data-recording medium. Included in the “time” associated with a specified event will typically be the date and time of day on that date that the event occurred.

In various implementations, particularly those involving the creation of documents intended to serve as evidence related to inventive activity, witnessing of at least one of (i) the existence of a data file and (ii) of the contents of the data file by a party other than the data file creator/depositor is facilitated. A method of facilitating data file witnessing includes the steps of: (a) rendering at least one of (i) evidence of the existence of the data file and (ii) the data file contents accessible to at least one witness candidate qualified in accordance with a set of predetermined conditions; (b) associating a unique, witness-specific signal with each qualified witness candidate which, when caused to be associated with a data file, constitutes evidence of an express manifestation of the witness candidate's intent to verify at least the existence of the data file; and (c) causing at least one of the at least one qualified witness candidate's to associate that witness candidate's unique signal with the data file thereby rendering that witness candidate a witness to at least the existence of the data file.

In at least some implementations that facilitate witnessing, a method further comprises the step of signaling at least one qualified witness candidate of the existence of a data file for which witnessing of at least one of (i) the existence of and (ii) contents of the file is desired. In alternative implementations, the signaling of a qualified witness may further include an indication that the data file for which witnessing is desired has been or is to be communicated over the data processing system for storage on a write-once data-recording medium. The signal to a witness candidate may be communicated over the data processing system and could assume any of numerous alternative forms including, by way of non-limiting example, an email prompting the witness candidate to access and witness an already-saved file and a copy of the file itself along with instructions to witness either or both of the files existence and its contents. An explicit witnessing of the existence of a data file in addition to the witnessing of contents of a data file may not be desired since, typically, the explicit witnessing of data file contents constitutes at least an implicit confirmation of the associated data file's existence.

In alternative implementations in which an intent to have a data file witnessed has been manifested through, for example, the communication of a signal to a qualified witness candidate, a method further comprises the step of associating with the data file the time of at least one of (i) data file access by each witness candidate of a selected set of witness candidates and (ii) the associating with the data file of the unique signal (e.g., code or private key) associated with a witness candidate. The time associated with a data file upon the occurrence of a particular event will typically be associated automatically and be based upon a time output from a system-wide time-keeping device. The implementation of an objective, system-wide measure of time further contributes to the reliability of data files “time-stamped” in accordance with outputs therefrom and establishes with greater clarity the chronology of data file contributions to a particular project from disparate sources, for example. For instance, if first and second inventors communicate data files over the data processing system for storage at time T₁ and a later time T₂, respectively, it is desirable that times T₁ and T₂ be identified with respect to a system-wide measure of time and not, for example, in accordance with the time-keeping devices of each of the first and second inventors personal computers since the time-keeping devices of the inventors' personal computers may not be synchronized.

In still additional implementations, a protocol is implemented for the secure, offsite warehousing of data-recording media containing data files intended to serve as evidence of inventive activity. In various versions, an independent third party is designated as “data custodian.” The data custodian periodically retrieves data files from the systems central data store and documents and maintains custody of the same in a secure location under the control of the custodian. Illustrative protocols involving a data custodian are described in greater depth in the detailed description section of this specification.

### BRIEF DESCRIPTION OF THE DRAWINGS

FIG. 1 is a diagram of an illustrative architecture for implementing a method of creating and archiving an authenticated data record;

FIG. 2 includes illustrative method steps representing a method of creating and archiving an authenticated data record in a data processing system; and

FIG. 3 depicts illustrative method steps facilitating data file witnessing.

### DETAILED DESCRIPTION

The following description of a system and method for archiving authenticated research and development records is illustrative in nature and is therefore not intended to limit the scope of the invention or its application of uses.

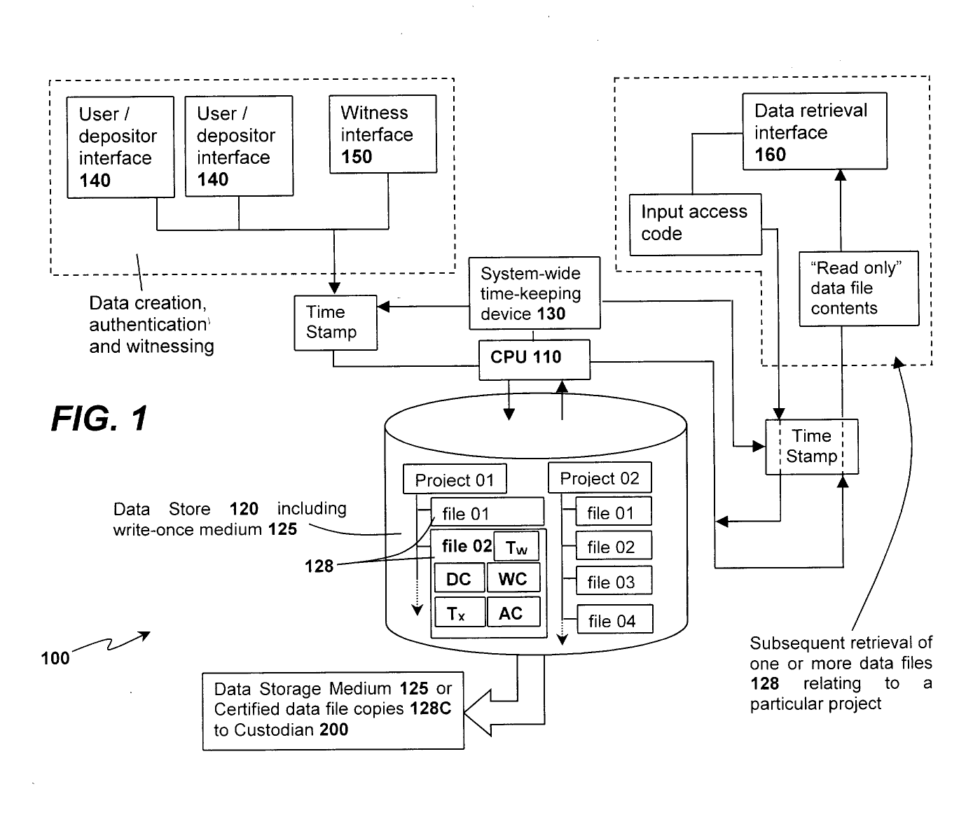

FIG. 1 is a diagram of an illustrative architecture for implementing a method of creating and archiving an authenticated data record. An illustrative data processing system 100 includes a central processing unit 110; a data store 120 including a write-once data recording medium 125; a system-wide time-keeping device 130; and at least one each of (i) a data-file depositor interface 140, (ii) a witness interface 150, and a (iii) data retrieval interface 160 through which an authorized user can retrieve data files saved to the data store 120 subsequent, for example, to the witnessing of the data file. It will be appreciated that a single terminal or networked personal computer, for example, could serve as one, two or all three of the aforementioned interfaces 140, 150 and 160. In various illustrative versions, alternative devices such as a telephone, a pager, a portable computer with a wireless modem, a fax machine, a digital camera, a video-recording device, and a scanner, by way of non-limiting example, are implemented, where so useable, as one or more of a data-file depositor interface 140, a witness interface 150, and a data retrieval interface 160.

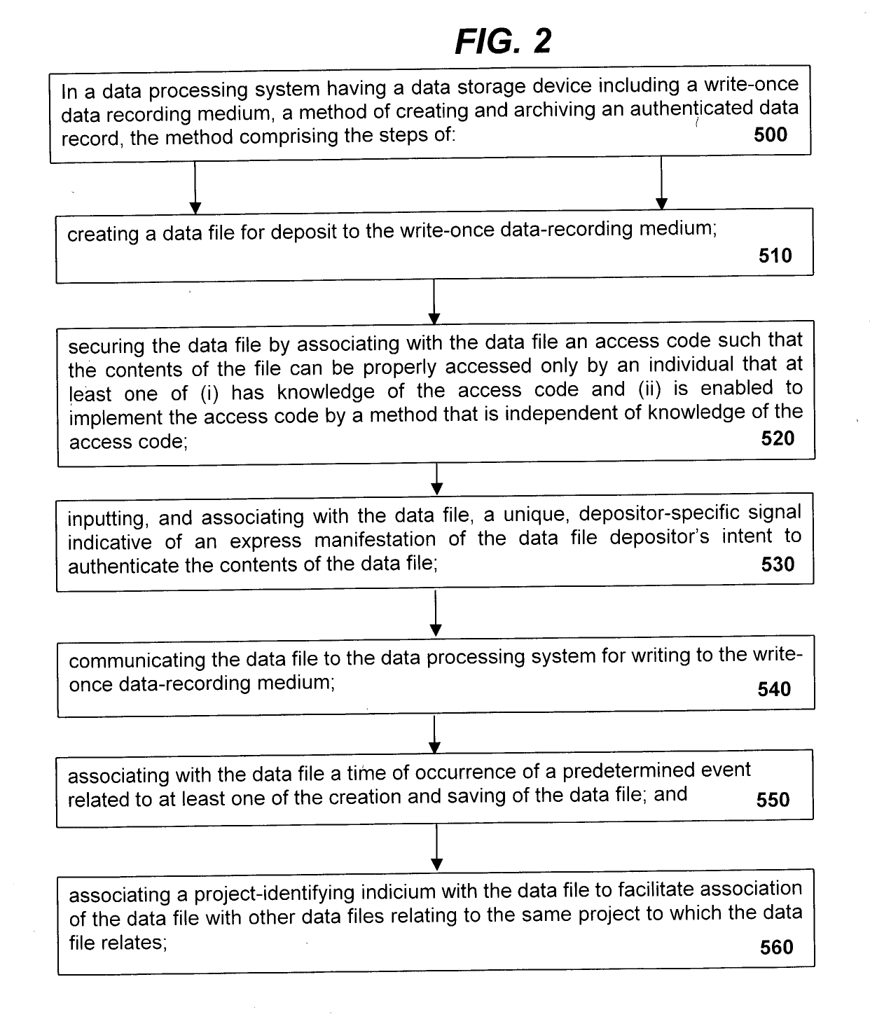

Referring to FIGS. 1 and 2, method steps represent an illustrative method of creating and archiving an authenticated data record in a data processing system 100 having a data storage device 120 including a write-once data recording medium 125. It should be noted that the sequences of steps presented in the drawings and described in the text are illustrative only and not necessarily indicative of the order in which the steps must be performed. Accordingly, nothing in the drawings, this description or the corresponding claims should be construed so as to limit the scope of the invention to a particular sequence of steps in the absence of explicit statements to the contrary or unless a particular order is inextricably dictated by context. For example, the existence or contents of a data file cannot be witnessed prior to the creation of the data. Reference is made to FIGS. 1 for illustrations of apparatus and architecture discussed in connection with data file creation, authentication and archiving methods.

In accordance with step 510 in FIG. 2, a user of the system 100 opens a data file 128 intended for deposit (e.g., saving) to the write-once data-recording medium 125. For the purposes of conceptualization and subsequent discussion, a data file 128 in FIG. 1 identified as “file 02” under “project 01” is referenced.

To protect the content of the data file 128 from unauthorized access, the data-file depositor, at step 520, secures the data file 128 by associating with the data file 128 an access code AC such that the contents of the data file 128 can be properly accessed only by an individual that at least one of (i) has knowledge of the access code AC and (ii) is enabled to implement the access code AC by a method that is independent of knowledge of the access code AC.

If the data file 128 is one for which user authentication is desired, the file depositor indicates an express manifestation of his or her intent to authenticate the contents of the data file 128 (e.g. “digitally signs”) by associating with the data file 128, a unique, depositor-specific signal (e.g., a user-specific code or password) DC indicative of such intent, as shown at step 530 and in association with illustrative “file 02” in FIG. 1. The depositor-specific code DC may be what is referred to as a “private key” known only to a specific user/data-file depositor, for example. Although a private key typically facilitates access to a data file for all purposes, including data alteration, in a typical implementation of the present invention, a file-depositor's association of his or her private key is used as a “signature” to evidence intent to authenticate a data file and, in a sense, claim “ownership,” of its associated contents. That is, in various implementations, not even the creator and depositor of the data file 128 can alter the data file contents once his or her code DC has been associated with the data file 128. By preventing alteration of a data file 128 subsequent to a user's association of his or her “digital signature” DC with that data file 128, the credibility and, therefore, the evidentiary value of the data file contents is maintained. Alterations to the contents of the data file 128 subsequent to the association of a depositor's unique code DC with the data file 128 are prevented, in various aspects, by the communication of the data file 128 through the data processing system 100 for writing to the write-once data-recording medium 125 as shown at illustrative step 540. For instance, the saving operation is automatically initiated upon a file depositor's association of his or her unique signature code DC with the data file 128 in an implementation in which such signal association, in essence, constitutes an instruction to unalterably and ineradicably write the file 128 and its contents to the write-once data-recording medium 125. In an illustrative alternative version, the data file 128 is communicated through the data processing system 100 for writing to the write-once data-recording medium 125 in response to an explicit “save” command.

In various implementations, a user with access desiring to build upon the data contained in a previously-saved data file 128 can open the saved data file 128 and modify as desired, but a subsequent authentication and save results in the creation of a new data file 128′ (not shown) separately identifiable from the previously-saved data file 128, thereby preserving the integrity of the previously-saved data file 128 as a credible record of the developmental status of the project as of a point in time permanently associated with the previously-saved data file 128. In one alternative implementation, the system 100 prompts and informs the file-depositor upon an attempt to save the modified data file 128 that the data file 128 cannot be saved under the identical name as the previously saved data file 128 and, furthermore, prohibits the user from disregarding this instruction. In another version, the system 100 is programmed to, upon an attempt to save a modified data file 128, save the data file 128 as a distinguishable version by, for example, including a time stamp as part of the file name or by otherwise indicating a distinction within the file name or elsewhere in association with the data file 128′.

At step 550, a time T_{X} indicative of the occurrence of a predetermined event related to at least one of the creation and saving of the data file 128 is associated with the data file 128. In various implementations, associated with the data file 128 is the time T_{X} of at least one of (i) the completion of data entry into the data file 128, (ii) the authentication of the data file 128 by the association therewith of the file depositor's unique signal DC, (iii) the communication of the data file 128 to the data processing system for saving and (iv) the completion of writing of the data file 128 to the write-once data-recording medium 125. Included in the “time” associated with a specified event will typically be the date and time of day on the date that the “time-stamped” event occurred.

To facilitate the association and ready retrieval of data files relating to a particular project, at step 560, a project-identifying indicium (e.g., “Project 01” as shown in FIG. 1) is associated with a data file 128. In various implementations, the data processing system 100 is programmed to prompt the user to associate the project-identifying indicium with the data file 128 at some point in time (e.g., prior to or subsequent to the occurrence) in relation to at least one specified event. For instance, in one illustrative version, when a user enters a command indicative of an intent to write the data file 128 to the data store 120, a prompt to identify the project with which the data file 128 is to be associated manifests itself to the user before saving is permitted.

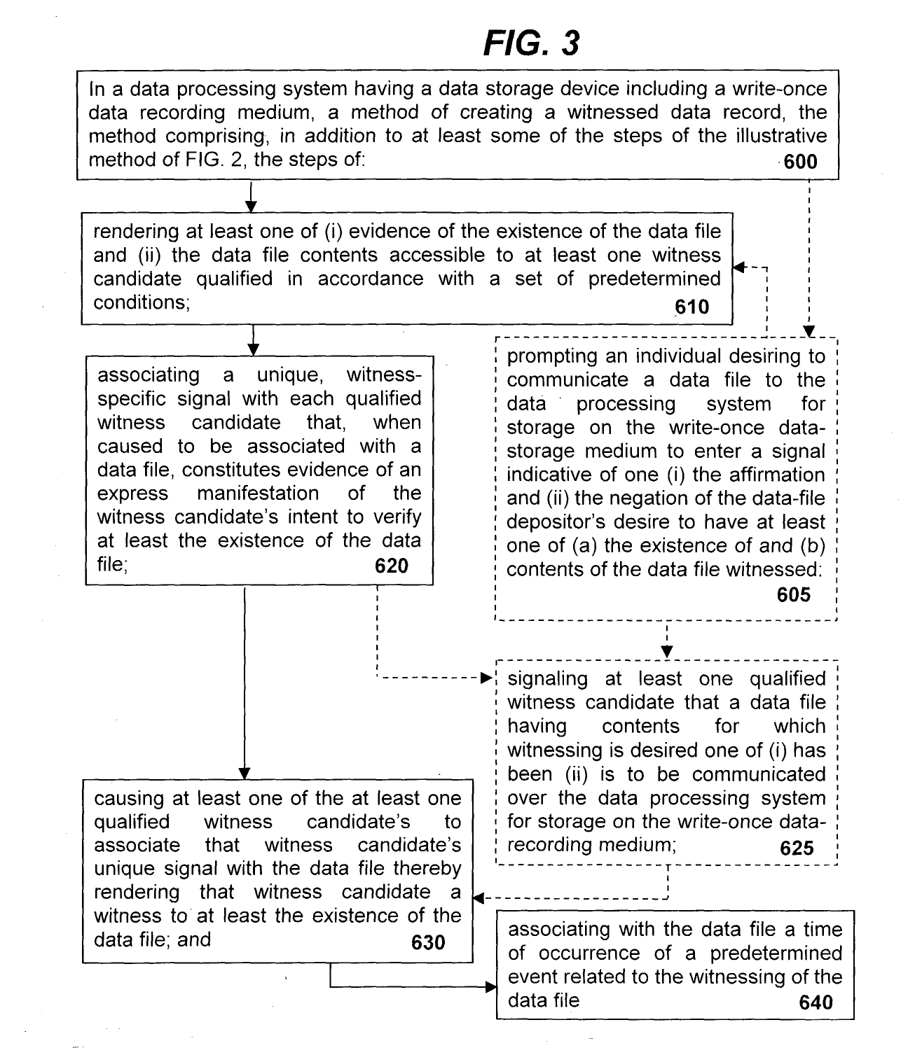

Method steps in addition to at least some of the method steps of FIG. 2 facilitate witnessing of at least one of (i) the existence of the data file 128 and (ii) of the contents of the data file 128 by a party other than the data file depositor. A need for witnessed data files 128 may arise, for instance, in the case of data files 128 including data that memorialize the developmental activity associated with an invention. Referring to FIG. 3, an illustrative method 600 of facilitating data file witnessing includes the steps of: (a) at step 610, rendering at least one of (i) evidence of the existence of the data file 128 and (ii) the data file contents accessible to at least one witness candidate qualified in accordance with a set of predetermined conditions; (b) associating, at step 620, a unique, witness-specific signal WC with each qualified witness candidate, which signal, when caused to be associated with a data file 128, constitutes evidence of an express manifestation of the witness candidate's intent to verify at least the existence of the data file 128; and (c) at step 630, causing at least one of the at least one qualified witness candidate's to associate that witness candidate's unique signal WC with the data file 128 thereby rendering that witness candidate a witness to at least the existence of the data file 128.

Alternative methods 600 of facilitating data file witnessing include at least one of steps 605 and 625 shown in dashed-line frames in FIG. 3. At step 605, an individual (e.g., a data-file depositor) desiring to communicate a data file 128 to the data processing system 100 for storage on the write-once data-storage medium 125 is prompted to enter a signal indicative of one (i) the affirmation and (ii) the negation of the data-file depositor's desire to have at least one of (a) the existence of and (b) contents of the data file 128 witnessed. At step 625, a step that may be included in a method either including or omitting step 605, at least one qualified witness candidate is signaled that a data file 128 for which witnessing is desired one of (i) has been (ii) is to be communicated over the data processing system for storage on the write-once data-recording medium 125. In an illustrative implementation omitting step 605, but including step 625, at least one qualified witness candidate is signaled as to the existence of a data file 128 for which witnessing is desired upon the occurrence of an event other than a file-depositor's signaled response to a prompt. For instance, the file-depositor may signal a qualified witness candidate without a prompt or a signal may be communicated to a witness candidate automatically upon the occurrence of a predetermined event related to at least one of the creation and saving of the data file 128 such as, by way of non-limiting example, at least one of (i) a command to write the file 128 to the write-once medium 125, (ii) the association of the file-depositor's unique signal DC with the data file 128, and (iii) the association of a project-identifying indicium with the data file 128.

In various methods providing for witnessing of a data file 128, a time of occurrence of a predetermined event related to the witnessing of the data file 128 is associating with the data file 128. The time(s) Tw associated with the data file 128 in connection with the witnessing thereof is, in a typical implementation, generated by a system-wide time keeping device 130, as shown in FIG. 1. A representative, non-exhaustive enumeration of witnessing-related times that could be tracked includes the times of (i) data file access by each witness candidate of a selected set of witness candidates and (ii) the associating with the data file 128 of the unique signal (e.g., code or private key) WC associated with a witness candidate.

In various implementations, the contents of data files 128 are protected from tampering through the involvement of a data custodian 200 as shown in FIG. 1. In a typical implementation involving a data custodian 200, the data custodian 200 is a fiduciary party having no proprietary or financial interest in the subject matter relating to the data files 128 nor any financial or personal relationship with any data-file depositor, witness or legal entity having an interest in the data file contents. In accordance with various versions, a protocol is established by which the data custodian 200 takes custody of data file contents from the data store 120 and independently retains the same on a memory device that is under the control of the data custodian 200. In one illustrative implementation, a data custodian 200, in accordance with a regular schedule, visits the site of the primary data store 120 and produces certified copies of data files 128 within the data store 120. The data custodian 200 then takes custody of the certified file copies 128C and transports them to a secure location under the control of the data custodian 200. In another version, a data custodian 200 takes physical custody of the centralized recording medium 125 on which the data files 128 are stored. In still another implementation, a data custodian 200 copies data files 128 from the data store 120 remotely over, for example, a computer network and creates and stores certified file copies 128C without having to physically appear at the site containing the data store 120. In still further versions, the data custodian 200 retrieves data files 128 from the data store 120 not in accordance with a regular schedule, but randomly or in accordance with a predetermined threshold amount of data stored in the data store 120, for example. For instance, a data custodian 200, in one illustrative version, receives a signal when the amount of data communicated to the write-once medium 125 in a data store 120 since some specified point in time (e.g., since the custodian's immediately previous data retrieval) reaches a predetermined number of bytes. Regardless of the manner by which, or the protocol in accordance with which, the contents of data files 128 are caused to be placed in the custody of the data custodian 200, reason suggests that the use of such a data custodian 200 who maintains a record of the data's chain of custody adds a further dimension of security and credibility to the contents of data files 128 and, hence, increases the evidentiary value of such records. Data files 128, once in the custody of the data custodian 200, are not readily susceptible to fraudulent manipulation.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact construction, implementations and versions shown and described.

What is claimed is:

1. In a data processing system having a data storage device including a writeonce data recording medium, a method of creating and archiving an authenticated data record, the method comprising the steps of:
creating a data file for deposit to the write-once data-recording medium;
securing the data file by associating with the data file an access code such that the contents of the file can be properly accessed only by an individual that at least one of (i) has knowledge of the access code and (ii) is enabled to a implement a method of file access that is independent of knowledge of the access code;
inputting, and associating with the data file, a unique, depositor-specific signal indicative of an express manifestation of the data-file depositor's intent to authenticate the contents of the data file;
associating a project-identifying indicium with the data file to facilitate association of the data file with other data files relating to the same project to which the data file relates;
communicating the data file to the data processing system for writing to the write-once data-recording medium; and
associating with the data file a time of occurrence of at least one predetermined event related to at least one of the creation and saving of the data file.

2. The method according to claim 1 wherein the time associated with the data file is indicative of the time of occurrence of at least one of (i) the completion of data entry into the file, (ii) the associating with the data file of the unique, depositor-specific signal, (iii) the communication of the data file to the data processing system and (iv) the completion of writing to the write-once data-recording medium.

3. The method according to claim 1 further comprising the steps of:
rendering accessible to at least one witness candidate qualified in accordance with a set of predetermined conditions at least one of (i) evidence of the existence of the data file and (ii) the data file contents associating a unique, witness-specific signal with each qualified witness candidate which, when caused to be associated with a data file, constitutes evidence of an express manifestation of the witness candidate's intent to verify at least the existence of the data file; and
causing at least one of the at least one qualified witness candidate's to associate that witness candidate's unique signal with the data file thereby rendering that witness candidate a witness to at least the existence of the data file.

4. The method according to claim 3 further comprising the step of signaling at least one qualified witness candidate that a data file for which witnessing is desired one of (i) has been and (ii) is to be communicated over the data 20 processing system for storage on the write-once data-recording medium.

5. The method according to claim 1 further comprising the steps of:
prompting a data-file depositor desiring to communicate a data file to the data processing system for storage on the write-once data-recording medium to 25 enter a signal indicative of one (i) the affirmation and (ii) the negation of the data-file depositor's desire to have at least one of (a) the existence of and (b) contents of the data file witnessed; and
as to a data file for which the data file depositor has entered a signal affirming the depositor's desire to have at least one of the (a) existence of and (b) contents of the data file witnessed, performing the following steps:
rendering at least one of (i) evidence of the existence of the data file and (ii) the data file contents accessible to at least one witness candidate qualified in accordance with a set of predetermined conditions;
associating a unique, witness-specific signal with each qualified witness candidate which, when caused to be associated with a data file, constitutes evidence of an express manifestation of the witness candidate's intent to verify at least the existence of the data file contents; and
causing at least one of the at least one qualified witness candidates to associate that witness candidate's unique signal with the data file thereby rendering that witness candidate a witness to at least the existence of the data file.

6. The method according to claim 5 further comprising the step of signaling at least one qualified witness candidate that a data file for which witnessing is desired one of (i) has been and (ii) is to be communicated over the data processing system for storage on the write-once data-recording medium.

7. The method according to claim 5, as applied to data files for which the data file depositor has signaled an intent to have at least one of (a) the existence of and (b) contents of the data file witnessed, further comprising the step of associating with the data file the time of occurrence of at least one predetermined event related to the witnessing of the data file.

8. The method according to claim 7 wherein the time related to the witnessing of the data associated with the data file is indicative of the time of occurrence of at least one of (i) data file access by each witness candidate of a selected set of witness candidates and (ii) the associating with the data file of the unique signal associated with a witness candidate.

9. The method according to claim 1 wherein at least a portion of at least one of the data processing system and the write-once data-recording medium is dedicated to the archiving of data records relating to the developmental activity associated with an invention.

10. The method according to claim 1 further comprising the step of:
causing to be placed in the custody of a data custodian at least one of (i) the write-once data-recording medium and (ii) a set of copies of data files including at least one data file copied from the write-once data-recording medium.

11. The method according to claim 10 further comprising the step of:
documenting a chain of custody of at least one of the applicable ones of the write-once data-recording medium and the set of file copies placed in the custody of the data custodian.

12. In a data processing system having a data storage device including a writeonce data recording medium, a method of creating and archiving an authenticated data record, the method comprising the steps of:
creating a data file for deposit to the write-once data-recording medium;
securing the data file by associating with the data file an access code such that the contents of the file can be properly accessed only by an individual that at least one of (i) has knowledge of the access code and (ii) is enabled to a implement a method of file access that is independent of knowledge of the access code;
inputting, and associating with the data file, a unique, depositor-specific signal indicative of an express manifestation of the data-file depositor's intent to authenticate the contents of the data file;
communicating the data file to the data processing system for writing to the write-once data-recording medium;
associating with the data file a time of occurrence of at least one predetermined event related to at least one of the creation and saving of the data file;
prompting a data-file depositor desiring to communicate a data file to the data processing system for storage on the write-once data-recording medium to enter a signal indicative of one (i) the affirmation and (ii) the negation of the data-file depositor's desire to have at least one of (a) the existence of and (b) contents of the data file witnessed; and
as to a data file for which the data file depositor has entered a signal affirming the depositor's desire to have at least one of the (a) existence of and (b) contents of the data file witnessed, performing the following steps:
rendering at least one of (i) evidence of the existence of the data file and (ii) the data file contents accessible to at least one witness candidate qualified in accordance with a set of predetermined conditions;
associating a unique, witness-specific signal with each qualified witness candidate which, when caused to be associated with a data file, constitutes evidence of an express manifestation of the witness candidate's intent to verify at least the existence of the data file contents; and
causing at least one of the at least one qualified witness candidates to associate that witness candidate's unique signal with the data file thereby rendering that witness candidate a witness to at least the existence of the data file.

13. The method according to claim 12 further comprising the step of signaling at least one qualified witness candidate that a data file for which witnessing is desired one of (i) has been and (ii) is to be communicated over the data processing system for storage on the write-once data-recording medium.

14. The method according to claim 12, as applied to data files for which the data file depositor has signaled an intent to have at least one of (a) the existence of and (b) contents of the data file witnessed, further comprising the step of associating with the data file the time of occurrence of at least one predetermined event related to the witnessing of the data file.

15. The method according to claim 14 wherein the time related to the witnessing of the data associated with the data file is indicative of the time of occurrence of at least one of (i) data file access by each witness candidate of a selected set of witness candidates and (ii) the associating with the data file of the unique signal associated with a witness candidate.

16. The method according to claim 12 wherein at least a portion of at least one of the data processing system and the write-once data-recording medium is dedicated to the archiving of data records relating to the developmental activity associated with an invention.

17. The method according to claim 12 further comprising the step of:
causing to be placed in the custody of a data custodian at least one of (i) the write-once data-recording medium and (ii) a set of copies of data files including at least one data file copied from the write-once data-recording medium.

18. The method according to claim 17 further comprising the step of:
documenting a chain of custody of at least one of the applicable ones of the write-once data-recording medium and the set of file copies placed in the custody of the data custodian.

19. In a data processing system having a data storage device including a writeonce data recording medium at least partially dedicated to the archiving of data records relating to the developmental activity associated with an invention, a method of creating and archiving an authenticated data record relating to the developmental activity associated with an invention comprising the steps of:
creating a data file for deposit to the write-once data-recording medium;
securing the data file by associating with the data file an access code such that the contents of the file can be properly accessed only by an individual that at least one of (i) has knowledge of the access code and (ii) is enabled to a implement a method of file access that is independent of knowledge of the access code;
inputting, and associating with the data file, a unique, depositor-specific signal indicative of an express manifestation of the data-file depositor's intent to authenticate the contents of the data file;
associating a project-identifying indicium with the data file to facilitate association of the data file with other data files relating to the same project to which the data file relates;
communicating the data file to the data processing system for writing to the write-once data-recording medium;
associating with the data file a time of occurrence of at least one predetermined event related to at least one of the creation and saving of the data file;
prompting a data-file depositor desiring to communicate a data file to the data processing system for storage on the write-once data-recording medium to enter a signal indicative of one (i) the affirmation and (ii) the negation of the data-file depositor's desire to have at least one of (a) the existence of and (b) contents of the data file witnessed; and
as to a data file for which the data file depositor has entered a signal affirming the depositor's desire to have at least one of the (a) existence of and (b) contents of the data file witnessed, performing the following steps:
signaling at least one witness candidate qualified in accordance with a set of predetermined conditions that a data file for which witnessing is desired one of (i) has been and (ii) is to be communicated over the data processing system for storage on the write-once data-recording medium;
rendering at least one of (i) evidence of the existence of the data file and (ii) the data file contents accessible to the at least one witness candidate;
associating a unique, witness-specific signal with each qualified witness candidate which, when caused to be associated with a data file, constitutes evidence of an express manifestation of the witness candidate's intent to verify at least the existence of the data file contents;
causing at least one of the at least one qualified witness candidates to associate that witness candidate's unique signal with the data file thereby rendering that witness candidate a witness to at least the existence of the data file; and
associating with the data file the time of occurrence of at least one predetermined event related to the witnessing of the data file.

20. The method according to claim 19 further comprising the steps of:
causing to be placed in the custody of a data custodian at least one of (i) the write-once data-recording medium and (ii) a set of copies of data files including at least one data file copied from the write-once data-recording medium; and
documenting a chain of custody of at least one of the applicable ones of the write-once data-recording medium and the set of file copies placed in the custody of the data custodian.
